(19) United States
(12) Patent Application Publication
(10) Pub. No.: US 2026/0151885 A1
(43) Pub. Date: Jun. 4, 2026

(54) FASTENER DRIVING TOOL

(71) Applicant: ZHEJIANG PRULDE ELECTRIC APPLIANCE CO., LTD., Jinhua (CN)

(72) Inventor: Chenghao YANG, Jinhua (CN)

(73) Assignee: ZHEJIANG PRULDE ELECTRIC APPLIANCE CO., LTD., Jinhua (CN)

(21) Appl. No.: 19/402,208

(22) Filed: Nov. 26, 2025

(30) Foreign Application Priority Data
Dec. 3, 2024 (CN) 202411764383X
Dec. 6, 2024 (CN) 202411793205X

(51) Int. Cl. B25C 1/04

(52) U.S. Cl. CPC B25C 1/044

(57) ABSTRACT

A fastener driving tool, relating to power tool; fastener driving tool includes gas chamber, piston, striker, lifer, support cylinder and movable cylinder body, movable cylinder body being disposed on inner circumference of support cylinder in up-and-down movable manner, movable cylinder body and support cylinder maintaining circumferential sealing fit, piston being disposed in movable cylinder body, gas chamber includes first and second gas chambers isolated from each other; first gas chamber disposed outside movable cylinder body, gas compressed in first gas chamber driving movable cylinder body to move downward relative to support cylinder, upward-moving piston driving movable cylinder to move upward relative to support cylinder, upward-moving movable cylinder body compressing gas in first gas chamber; gas compressed in second gas chamber drives piston to move downward relative to movable cylinder body, upward-moving piston compressing gas in second gas chamber. This structural improvement ensures nailing effect while reducing vibration felt by user.

### FIELD

The present disclosure relates to power tools, and more particularly relates to a fastener driving tool.

### BACKGROUND

A nail gun is a handheld nail driving tool that leverages a quickly-moving striker to drive a nail into a workpiece such as wood. Traditional pneumatic nail guns generally adopt a dual-cylinder dual-piston structure, where after the large piston in the larger cylinder moves to compress the gas in the larger cylinder to a predetermined level, the small piston in the smaller cylinder is released, so that the compressed gas in the larger cylinder flows through a gas passage into the smaller cylinder, driving the small piston in the smaller cylinder to move at a high velocity, and the moving small piston then actuates the striker to move synchronously, so that the striker drives a nail into the workpiece such as wood, thereby fulfilling the objective of nail driving. The traditional pneumatic nail guns generally adopt a crank train to drive the large piston to move reciprocally. Since the crank train produces a large load-bearing deflection angle during its reciprocating motion, conditions such as thrust instability and excessive eccentric load easily occur when the crank train actuates the large piston to compress the gas, which in turn may jam the large piston during a gas-compressing process of the large piston.

To address the conditions noted supra, some pneumatic guns (e.g., U.S. Pat. No. 11,034,007B2 and its earlier patents) use a single-piston single-chamber structure instead, where pressurized gas is filled in the gas storage chamber, the upward moving piston compresses the gas in the gas storage chamber, and then the pressured gas in the storage chamber may actuate the piston to drive the striker to move quickly, thereby driving a nail into a workpiece. Since only one gas storage chamber is provided, it only performs the acceleration action once on the piston, which plays a limited role in enhancing the nailing effect.

### SUMMARY

To overcome the above drawbacks and disadvantages of conventional technologies, the present disclosure provides a fastener driving tool, which ensures nailing effect while reducing vibration felt by a user.

A fastener driving tool according to the present disclosure comprises:
a gas chamber in which pressurized gas is filled;
a piston movable up and down, the piston being driven to move downward by the gas compressed in the gas chamber;
a striker, an upper end of which is attached to the piston, the striker moving downward with the piston to drive a to-be-driven fastener into a workpiece;
and a lifter configured to drive the piston and the striker to move upward;
wherein the fastener driving tool further comprises a support cylinder and a movable cylinder body, where:
the support cylinder is fixedly disposed and extends in an upper and lower direction;
the movable cylinder body is disposed on an inner circumference of the support cylinder in an up-and-down movable manner, the movable cylinder body and the support cylinder maintain a circumferentially sealing fit, and the piston is disposed in the movable cylinder body in an up-and-down movable manner;
the gas chamber includes a first gas chamber and a second gas chamber isolated from each other, where:
the first gas chamber is disposed outside the movable cylinder body, the movable cylinder body is driven by the gas compressed in the first gas chamber to move downward relative to the support cylinder, the movable cylinder body is driven by the piston moving upward to move upward relative to the support cylinder, and the movable cylinder body moving upward compresses the gas in the first gas chamber;
and the second gas chamber is formed by fitting between the movable cylinder body and the piston, the piston is driven by the gas compressed in the second gas chamber to move downward relative to the movable cylinder body, and the gas in the second gas chamber is compressed by the piston moving upward.

In some implementations, the movable cylinder body has a sidewall and a top wall located at a top end of the sidewall, the first gas chamber being at least partially located above the top wall.

In some implementations, the piston, the striker, and the movable cylinder body have a ready position, the movable cylinder body in the ready position being completely disposed in the support cylinder.

In some implementations, the piston, the striker, and the movable cylinder body have a ready position, the movable cylinder body in the ready position being disposed at least partially higher than the support cylinder.

In some implementations, a limiting portion adapted to the movable cylinder body is provided over the support cylinder, and the movable cylinder body moving toward the ready position is extendable out of the support cylinder into the limiting portion.

In some implementations, the piston, the striker, and the movable cylinder body have an end position, an upper end of the movable cylinder body in the end position being higher than or flush with an upper end of the support cylinder.

In some implementations, the piston, the striker, and the movable cylinder body have an end position, and the fastener driving tool further comprises a damper block secured at a lower end of the support cylinder, a lower end of the movable cylinder body in the end position being pressed on the damper block.

In some implementations, the movable cylinder body has a sidewall and a top wall located at a top end of the sidewall, the first gas chamber being disposed completely at the top end of the movable cylinder body.

In some implementations, a cylinder head is provided at an upper end of the support cylinder, and the first gas chamber is enclosed by the support cylinder, the cylinder head, and the top wall of the movable cylinder body.

In some implementations, the support cylinder has an outer diameter consistent from top to bottom; or, the support cylinder has an outer diameter decreasing gradually from top to bottom with a stepped portion formed, the movable cylinder body being always not higher than the stepped portion.

In some implementations, a limiting cover is provided at the lower end of the movable cylinder body, an elastic block is provided at one side of the limiting cover facing the movable cylinder body and located below the piston, and the elastic block and the limiting cover are both provided with a clearance hole for the striker to pass through.

The present disclosure further provides a fastener driving tool, comprising:
a gas chamber, in which pressurized gas is filled;
a piston movable up and down, the piston being driven to move downward by the gas compressed in the gas chamber;
a striker, an upper end of which is attached to the piston, the striker moving downward with the piston to drive a to-be-driven fastener into a workpiece;
a lifter configured to drive the piston and the striker to move upward;
wherein the fastener driving tool further comprises an inner cylinder block, a through hole being formed in an upper end of the inner cylinder block, where:
the piston is disposed in the inner cylinder block, the piston and the striker having an upper ready position and a lower end position;
the gas chamber includes a first gas chamber and a second gas chamber, the first gas chamber being disposed outside the inner cylinder block, the second gas chamber being defined at least by fitting between the inner cylinder block and the piston;
the through hole is opened when the piston moves from the ready position to the end position so that the first gas chamber communicates with the second gas chamber;
and the through hole is closed when the piston moves from the end position to the ready position so that the first gas chamber is isolated from the second gas chamber.

In some implementations, a plurality of through holes are distributed at intervals along a circumferential direction of the inner cylinder block.

In some implementations, a sealing ring is provided between the piston and the inner cylinder block to maintain a circumferential sealing fit therebetween; at least two sealing rings are provided at an interval in an upper and lower direction; and the through holes are located between adjacent two sealing rings when the piston is in the ready position.

With the technical solution, the present disclosure offers the following benefits:
1. In the first solution, the fastener driving tool according to the present disclosure is provided with a support cylinder and a movable cylinder body, where the movable cylinder body partitions the gas chamber into a first gas chamber and a second gas chamber isolated from each other. To perform a nailing action, the pressurized gas in the first gas chamber drives the movable cylinder body to move downward relative to the support cylinder, and the pressurized gas in the second gas chamber drives the striker to move downward relative to the movable cylinder body; with the pressurized gas in the two gas chambers, the piston may be accelerated twice during the nailing action, which helps to increase the movement speed of the striker and thereby enhances nailing effect. When the lifter drives the piston and the striker to move upward, the upward-moving piston may compress the gas in the second gas chamber, which can also drive the movable cylinder body to move upward, the upward-moving movable cylinder body may compress the gas in the first gas chamber, and the upward-moving piston compresses the gas in the first gas chamber and the second gas chamber simultaneously. Since the two gas chambers are constantly filled with the pressurized gas, the nailing force can be ensured. In addition, with the dual-chamber structure, the vibration produced by the striking action when the striker engages the fastener can be damped twice by the gas in the two gas chambers, which significantly buffers the vibration produced by the striking action while satisfying the nailing requirements, thereby enhancing user experience.
2. In the second solution, the fastener driving tool according to the present disclosure provides a through hole in an upper end of the inner cylinder block; the through hole is closable/openable by the piston to communicate or isolate the two gas chambers. During movement of the piston from the ready position to the end position, the pressurized gas in the second gas chamber first acts on the piston; after the piston moves downward to open the through hole, the pressurized gas in the first gas chamber may flow into the second gas chamber via the through hole while acting on the piston; the two communicable gas chambers may accelerate the piston twice in one nailing action, which helps to increase the movement speed of the striker and thus enhances the nailing effect. In addition, with the two gas chambers, the vibration produced from the striking action when the striker engages the fastener can be damped twice by the gas in the two gas chambers, which significantly buffers the vibration produced by the striking action while satisfying the nailing requirements, thereby enhancing user experience.

### BRIEF DESCRIPTION OF THE DRAWINGS

FIG. 1 is an overall view of a fastener driving tool in a first embodiment;

FIG. 2 is a schematic diagram when a fastener is not driven into a workpiece yet according to the first embodiment;

FIG. 3 is a schematic diagram after the fastener is driven into the workpiece according to the first embodiment;

FIG. 4 is a partial structural view of the fastener driving tool according to the first embodiment;

FIG. 5 is an exploded view of a partial structure according to the first embodiment;

FIG. 6 is an anteroposterior sectional view of a support base, a guide base, and a striker according to the first embodiment;

FIG. 7 is a schematic view of fitting between a lifting gear and the striker according to the first embodiment;

FIG. 8 is an axial sectional view of a partial structure when a piston, the striker, and a movable cylinder body are in a ready position in the first implementation;

FIG. 9 is an axial sectional view of a partial structure when the piston, the striker, and the movable cylinder body are in an end position;

FIG. 10 is an exploded view of a lifter according to the first embodiment;

FIG. 11 is a structural view of fitting between a partial structure of the lifter and a latching block according to the first embodiment;

FIG. 12 is an axial sectional view of a partial structure of the lifter according to the first embodiment;

FIG. 13 is a structural view of fitting between a driving wheel and a driven wheel according to the first embodiment;

FIG. 14 is a structural view of the driving wheel according to the first embodiment;

FIG. 15 is a structural view of fitting between a cam and the latching block according to the first embodiment;

FIG. 16 is a structural view of fitting between the latching block and a limit switch according to the first embodiment;

FIG. 17 is an exploded view of a safety assembly and the guide base according to the first embodiment;

FIG. 18 is an axial sectional view of a partial structure when an outer cylinder body adopts an irregular structure according to the first embodiment;

FIG. 19 is an axial sectional view of a partial structure of a fastener driving tool when a piston, a striker, and a movable cylinder body are in a ready position according to a second embodiment;

FIG. 20 is an axial sectional view of the partial structure of the fastener driving tool when the piston, the striker, and the movable cylinder body are in an end position according to the second embodiment;

FIG. 21 is a schematic diagram when a support cylinder and a limiting portion are unitarily formed according to the second embodiment;

FIG. 22 is an axial sectional view of a partial structure of a fastener driving tool when a piston, a striker, and a movable cylinder body are in a ready position according to a third embodiment;

FIG. 23 is an axial sectional view of the partial structure of the fastener driving tool when the piston, the striker, and the movable cylinder body are in an end position according to the third embodiment;

FIG. 24 is an axial sectional view of the partial structure when the piston, the striker, and the movable cylinder body are in a ready position in a case that a support cylinder adopts another solution according to the third embodiment;

FIG. 25 is an axial sectional view of the partial structure when the piston, the striker, and the movable cylinder body are in a ready position in a case that the movable cylinder body adopts a further solution according to the third embodiment;

FIG. 26 is an axial sectional view of a partial structure of a fastener driving tool when a piston and a striker are in a ready position according to a fourth embodiment;

FIG. 27 is an axial sectional view of the partial structure of the fastener driving tool when the piston and the striker are in an end position according to the fourth embodiment;

FIG. 28 is an axial sectional view of the partial structure when the piston and the striker are in a ready position in a case that an inner cylinder block adopts another solution according to the fourth embodiment.

In the drawings: 100—fastener driving tool;
10, 10′—gas chamber; 10A, 10A′—first gas chamber; 10B, 10B′—second gas chamber;
21—piston; 211—sealing ring; 22—striker; 221—convex tooth; 222—slot; 23—support cylinder; 231—stepped portion; 24—movable cylinder body; 241—sidewall; 242—top wall; 243—limiting cover; 244—elastic block; 245—clearance hole; 25—base; 261—outer cylinder body; 262—inner cylinder block; 262a—side cylinder wall; 262b—top cylinder wall; 263—through hole; 264—sealing gasket; 27—cylinder head; 28—damper block; 281—central hole; 291—limiting portion; 292—flow channel;
31—fastener; 32—workpiece;
40—lifter; 41—lifting gear; 42—transmission shaft; 43—electric motor; 44—reduction gearbox; 441—output shaft; 451—driving wheel; 4511—recessed cavity; 452—driven wheel; 461—drive ratchet groove; 462—drive ratchet; 463—first spring;
50—enclosure; 51—body portion; 52—accommodation portion; 53—grip portion; 54—connecting portion; 55—reinforcement portion;
61—support base; 62—rod shaft; 63—guide base; 64—limiting passage; 65—guide passage; 66—trigger;
71—latching block; 72—second spring; 73—cam; 74—limit switch; 75—pin rod;
80—nail feeder; 81—guide cover;
90—safety assembly; 91—driver rod; 92—safety switch; 93—third spring; 94—contact plate; 95—locating rack; 96—elastic member.

### DETAILED DESCRIPTION OF EMBODIMENTS

Hereinafter, the present disclosure will be further described through specific embodiments referring to the drawings. It is appreciated that the orientational or positional relationships indicated by the terms “upper,” “lower,” “left,” “right,” “longitudinal,” “transverse,” “inner,” “outer,” “vertical,” “horizontal,” “top,” and “bottom” are orientational and positional relationships based on the drawings, which are intended only for facilitating description of the disclosure and simplifying relevant illustrations, not for indicating or implying that the devices or elements compulsorily possess those specific orientations and are compulsorily configured and operated with those specific orientations; therefore, such terms should not be construed as limitations to this disclosure.

### First Embodiment

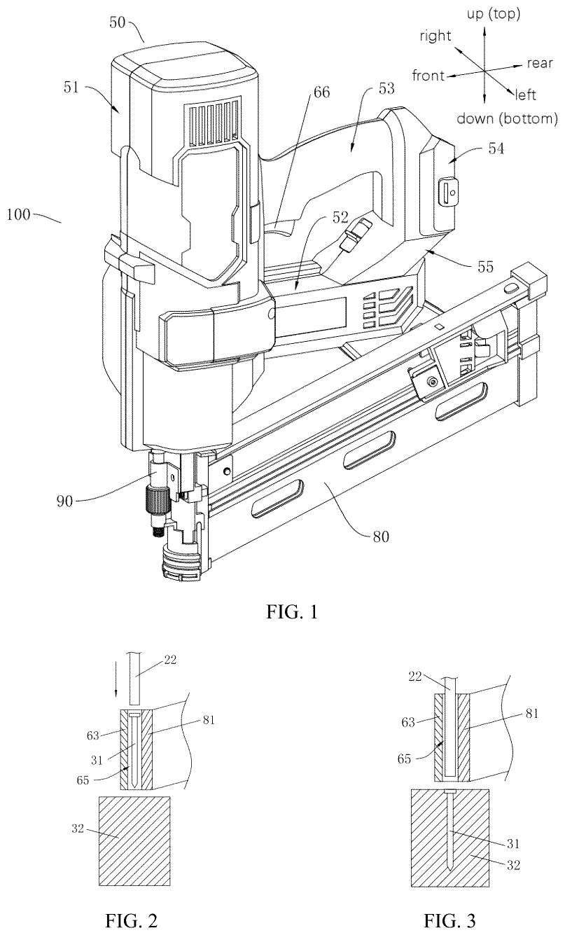

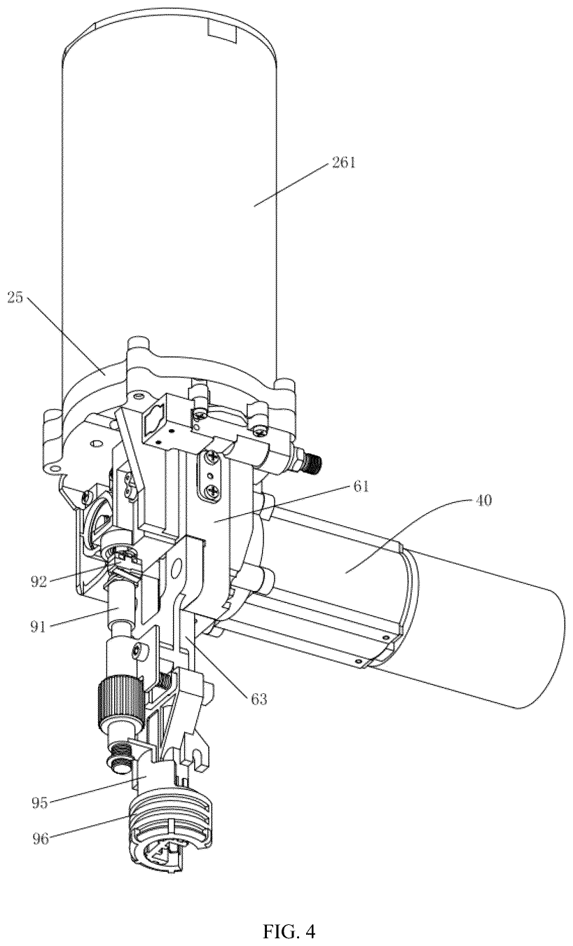

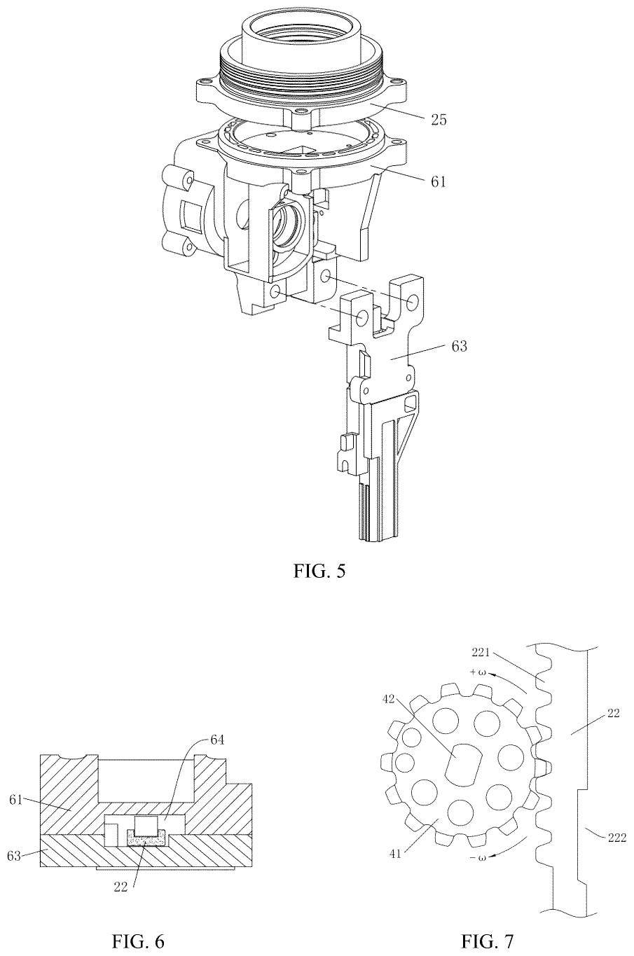

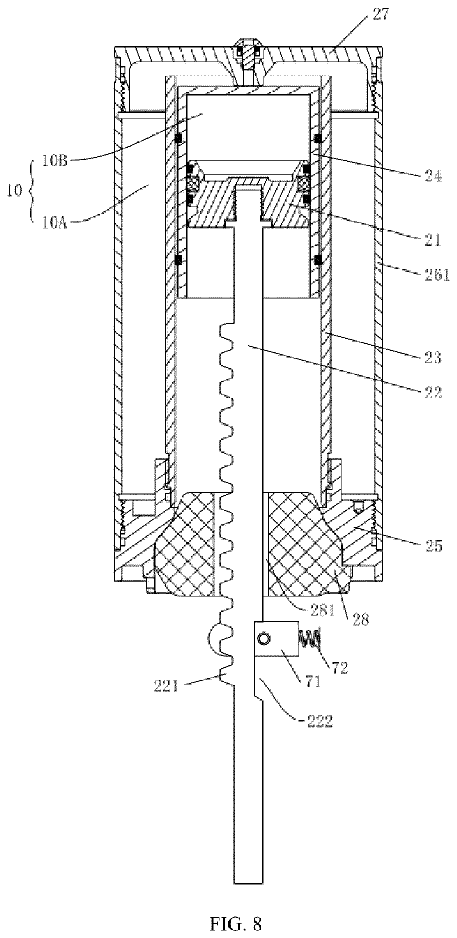

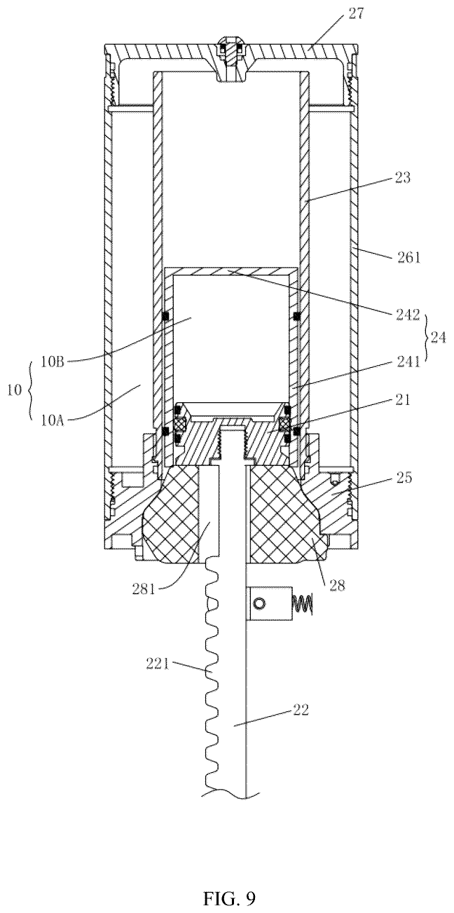

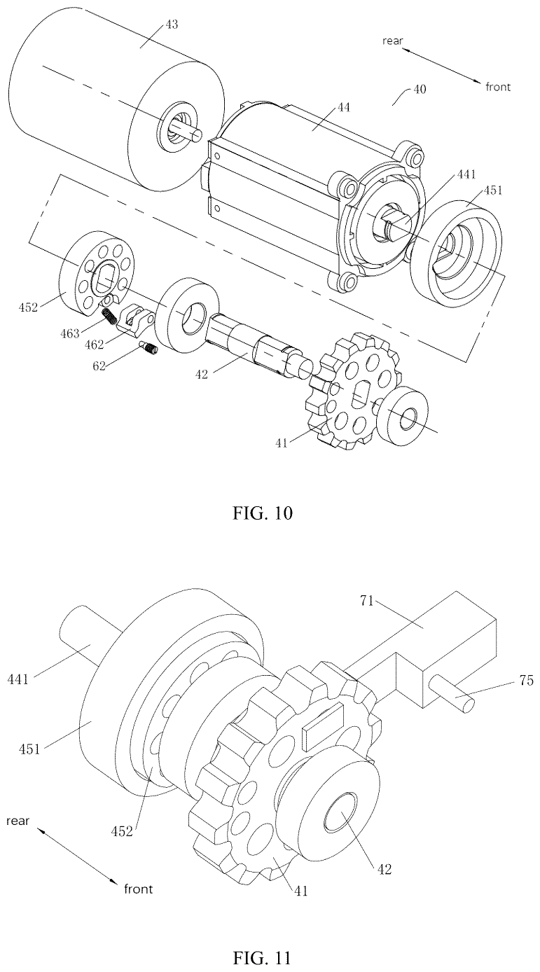

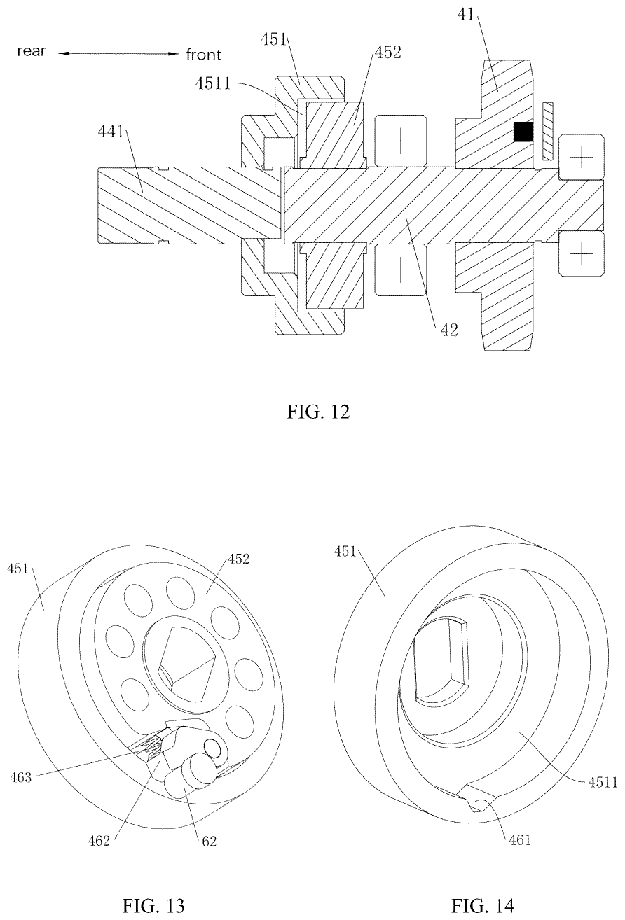

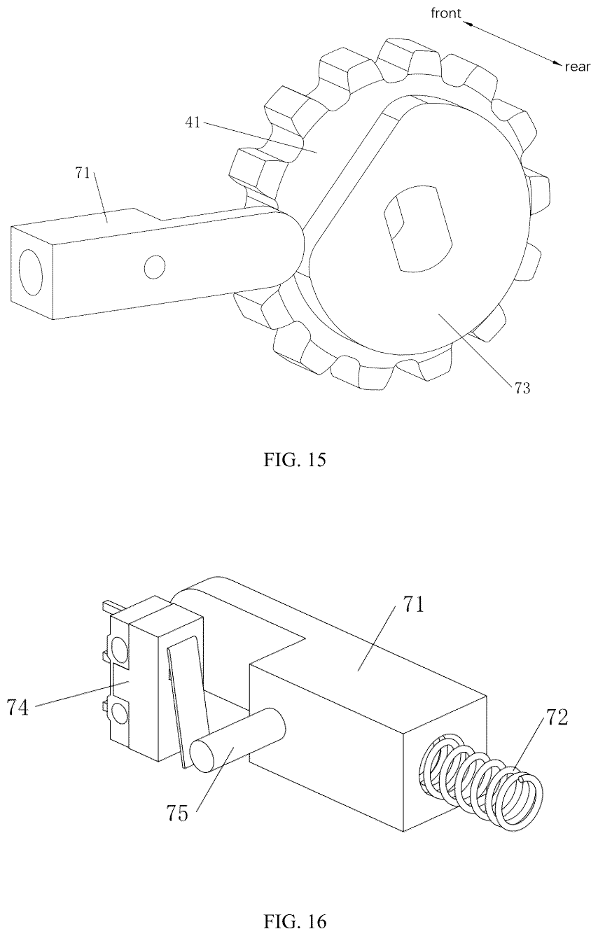

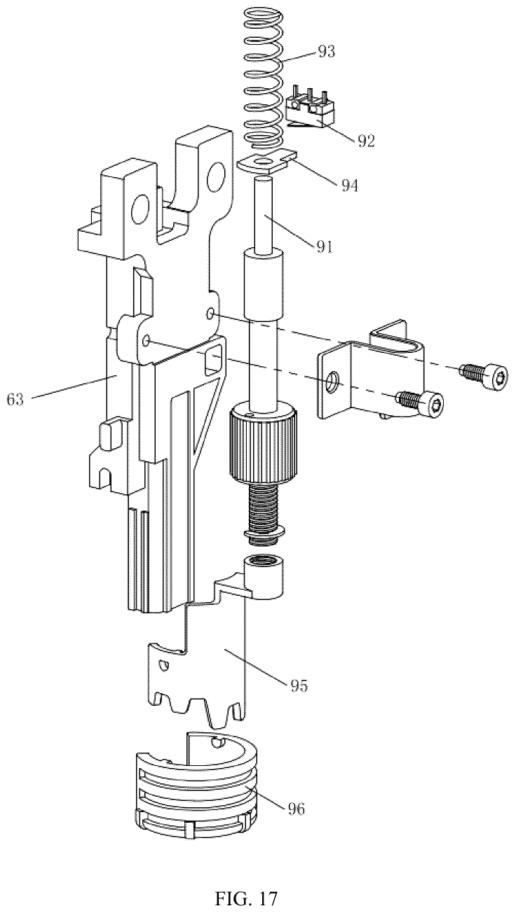

Referring to FIGS. 1 to 17, a fastener driving tool 100 according to a first embodiment comprises:
a gas chamber 10 in which pressurized gas is filled;
a piston 21 movable up and down, the piston 21 being driven to move downward by the gas compressed in the gas chamber 10;
a striker 22, an upper end of which is attached to the piston 21, the striker 22 moving downward with the piston 21 to drive a to-be-driven fastener 31 into a workpiece 32;
a lifter 40 configured to drive the piston 21 and the striker 22 to move upward;
the fastener driving tool 100 further comprising a support cylinder 23 and a movable cylinder body 24, where:
the support cylinder 23 is fixedly disposed and extends in an upper and lower direction;
the movable cylinder body 24 is disposed on an inner circumference of the support cylinder 23 in an up-and-down movable manner, the movable cylinder body 24 and the support cylinder 23 maintain a circumferentially sealing fit, and the piston 21 is disposed in the movable cylinder body 24 in an up-and-down movable manner;
the gas chamber 10 includes a first gas chamber 10A and a second gas chamber 10B isolated from each other, where:
the first gas chamber 10A is disposed outside the movable cylinder body 24, the movable cylinder body 24 can be driven by the gas compressed in the first gas chamber 10A to move downward relative to the support cylinder 23, the movable cylinder body 24 can be driven by the piston 21 moving upward to move upward relative to the support cylinder 23, and the movable cylinder body 24 moving upward compresses the gas in the first gas chamber 10A;
and the second gas chamber 10B is formed by fitting between the movable cylinder body 24 and the piston 21, the piston 21 can be driven by the gas compressed in the second gas chamber 10B to move downward relative to the movable cylinder body 24, and the gas in the second gas chamber 10B may be compressed by the piston 21 moving upward.

To perform a nailing action, the pressurized gas in the first gas chamber 10A drives the movable cylinder body 24 to move downward relative to the support cylinder 23, and the pressurized gas in the second gas chamber 10B drives the striker 22 to move downward relative to the movable cylinder body 24. The pressurized gas in the two gas chambers enables the piston 21 to be accelerated twice during the nailing action, which helps increase the movement speed of the striker 22 and thereby improves the nailing effect. With the dual-gas-chamber structure, the vibration produced from the striking action when the striker 22 engages the fastener 31 can be damped twice by the gas in the two gas chambers, which can significantly reduce the vibration produced from the striking action while meeting the nailing requirements, thereby enhancing user experience.

In this embodiment, the fastener driving tool 100 further comprises an enclosure 50. The enclosure 50 exemplarily adopts a laterally oppositely openable housing structure, and is formed with a body portion 51, an accommodation portion 52, and a grip portion 53, the body portion 51 extending substantially in an upper and lower direction; the accommodation portion 52 extending rearward from a lower section of the body portion 51 and being configured to accommodate a part of the components of the lifter 40, the grip portion 53 extending rearward from an upper section of the body portion 51 and being adapted for a user to grip, a certain gap being present in an upper and lower direction between the grip portion 53 and the accommodation portion 52. The fastener driving tool 100 of this embodiment is exemplarily powered by a battery pack, which is exemplarily mounted in a detachable manner. A connecting portion 54 configured to accommodate the battery pack is formed at a rear end of the grip portion 53.

The fastener driving tool 100 further comprises a base 25, an outer cylinder body 261, and a cylinder head 27; the base 25 is secured in the body portion 51; the support cylinder 23 is open on both upper and lower ends, the lower end of the support cylinder 23 being secured on the base 25 and maintaining a sealing fit with the base 25; the outer cylinder body 261 is sleeved on an outer circumference of the support cylinder 23, a lower end of the outer cylinder body 261 being secured on the base 25 and maintaining a sealing fit with the base 25; the cylinder head 27 is secured to an upper end of the outer cylinder body 261 and maintains a sealing fit with the outer cylinder body 261. The movable cylinder body 24 comprises a sidewall 241 and a top wall 242 disposed on a top end of the sidewall 241; and an axially positioned sealing ring is sleeved on an outer circumference of the sidewall 241, the sealing ring being adapted to maintain a circumferential sealing fit between the sidewall 241 and the support cylinder 23. A height gap exists between a bottom surface of the cylinder head 27 and a top surface of the support cylinder 23. A space enclosed by the outer cylinder body 261, the support cylinder 23, the base 25, the cylinder head 27, and the top wall 242 of the movable cylinder body 24 is defined as the first gas chamber 10A, the first gas chamber 10A is partially located above the top wall 242 of the movable cylinder body 24, so that the pressurized gas in the first gas chamber 10A can smoothly act on the movable cylinder body 24. The movable cylinder body 24 has its upper end closed and its lower end open; an axially positioned sealing ring is also sleeved on an outer circumference of the piston 21, allowing for the piston 21 and the movable cylinder body 24 to maintain a circumferential sealing fit therebetween; a space enclosed by the movable cylinder body 24 and the piston 21 is defined as the second gas chamber 10B. Pressurized gas is prefilled in the first gas chamber 10A and the second gas chamber 10B; the gas pressures in the two gas chambers can be set to be substantially identical or different. To adjust the gas pressure, two inflation valves can be configured to inflate the two gas chambers, respectively; or two exhaust valves can be configured to exhaust the two gas chambers, respectively; of course, a one-way valve adapted to balance the gas pressures in the two gas chambers can also be provided on the top wall 242 of the movable cylinder body 24 to avoid excessive pressure difference between the two gas chambers.

A damper block 28 is provided at a lower end of the support cylinder 23 and disposed on an inner circumference of the base 25. The damper block 28 is made of an elastic material such as rubber and configurable to limit extreme positions of downward movement of the movable cylinder body 24 and the piston 21, preventing the movable cylinder body 24 from being disengaged from the support cylinder 23 and preventing the piston 21 from being disengaged from the movable cylinder body 24. A central hole 281 configured for the striker 22 to pass through is provided in a center of the damper block 28.

In this embodiment, an upper end of the striker 22 is connected to the piston 21 via threaded fit, pinhole fit, or the like. The piston 21, the striker 22, and the movable cylinder body 24 have an upper ready position and a lower end position. The piston 21, the striker 22, and the movable cylinder body 24 are normally in the ready position, in which case the movable cylinder body 24 is completely disposed in the support cylinder 23, i.e., the top wall 242 of the movable cylinder body 24 is disposed lower than or flush with an upper end of the support cylinder 23, the gas in the first gas chamber 10A and the second gas chamber 10B being in a higher-pressure state, respectively. To perform a nailing action, the piston 21, the striker 22, and the movable cylinder body 24 move from the ready position to the end position, the higher-pressure gas in the first gas chamber 10A actuates the movable cylinder body 24 to drive the piston 21 to move downward, and the pressurized gas in the second gas chamber 10B actuates the piston 21 to move downward relative to the movable cylinder body 24. When the movable cylinder body 24 and the piston 21 both contact the damper block 28, the piston 21, the striker 22, and the movable cylinder body 24 move downward to the end position, in which case the gas in the first gas chamber 10A and the second gas chamber 10B is in a low-pressure state, respectively. The piston 21 moving upward from the end position to the ready position compresses the gas in the second gas chamber 10B while the upward-moving piston 21 can drive the movable cylinder body 24 to move upward such that the movable cylinder body 24 moves upward to compress the gas in the first gas chamber 10A. It is appreciated that the piston 21 in the end position can also be disposed higher than the damper block 28 without contacting the latter.

In this embodiment, the striker 22 is provided with a plurality of convex teeth 221 distributed at intervals in an upper and lower direction. The lifter 40 comprises an electric motor 43, a reduction gearbox 44, and a lifting gear 41. The lifting gear 41 can mesh with the convex teeth 221 on the striker 22 to drive the striker 22 to move upward toward the ready position while the striker 22 moving upward drives the piston 21 and the movable cylinder body 24 to move upward toward the ready position. Specifically, the electric motor 43 and the reduction gearbox 44 are arranged in the accommodation portion 52 of the enclosure 50; a support base 61 is secured below the base 25, the lifting gear 41 is sleeved on a transmission shaft 42, the transmission shaft 42 is rotatably mounted on the support base 61 via a bearing, and an axial direction of the lifter 40 is substantially perpendicular to a length direction of the striker 22. A driving wheel 451 is sleeved on an output shaft 441 of the reduction gearbox 44, a driven wheel 452 is sleeved on a rear end of the transmission shaft 42, and an engageable and disengageable transmission structure is provided between the driving wheel 451 and the driven wheel 452. When the transmission structure is in an engaged state, the electric motor 43 drives the driving wheel 451 to rotate via the reduction gearbox 44, the rotating driving wheel 451 drives the transmission shaft 42 to rotate about its own central axis via the transmission structure, the rotating transmission shaft 42 drives the lifting gear 41 to rotate synchronously in the direction indicated by +ω, the lifting gear 41 rotating in the +ω direction drives the striker 22 to move upward toward the ready position via meshing with the convex teeth 221, and the striker 22 moving upward drives the piston 21 and the movable cylinder body 24 to also move toward the ready position.

Specifically, a recessed cavity 4511 is formed on one side of the driving wheel 451 facing the driven wheel 452, the driven wheel 452 being disposed in the recessed cavity 4511. The transmission structure comprises a drive ratchet groove 461 formed on an inner wall of the recessed cavity 4511, a drive ratchet 462 arranged on the driven wheel 452 in a swingable manner, and a first spring 463 configured to bias the drive ratchet 462 toward the inner wall of the recessed cavity 4511. A rod shaft 62 configured to drive the drive ratchet 462 away from the drive ratchet groove 461 is provided on the support base 61. When the drive ratchet 462 is biased by the first spring 463 and fitted in the drive ratchet groove 461, the transmission structure is in an engaged state. The driving wheel 451 driven to rotate by the electric motor 43 then drives, via the fit between the drive ratchet groove 461 and the drive ratchet 462, the transmission shaft 42 and the lifting gear 41 to rotate in the +ω direction, so that the lifting gear 41 can drive the striker 22, the piston 21, and the movable cylinder body 24 to move upward to the ready position. When the drive ratchet 462 is pushed by the rod shaft 62 to overcome the bias of the first spring 463 to disengage from the drive ratchet groove 461, the transmission structure is in a disengaged state; to perform a nailing action, the downward-moving striker 22 drives the lifting gear 41 to rotate in the direction indicated by −ω, and the lifting gear 41 rotating in the —ω direction drives the transmission shaft 42 and the driven wheel 452 to rotate freely relative to the driving wheel 451; this prevents transmission of the reverse rotation to the reduction gearbox 44. To drive the striker 22 to return to the ready position, the rotating driving wheel 451 can drive the drive ratchet 462 to be re-fitted into the drive ratchet groove 461.

A slidable latching block 71 is provided on the support base 61 to lock the striker 22, the piston 21, and the movable cylinder body 24 normally in the ready position, a sliding direction of the latching block 71 being substantially perpendicular to a movement direction of the striker 22. Specifically, the latching block 71 is disposed on the support base 61 in a left-right slidable manner, a slot 222 fitted with the latching block 71 is formed on the lower end of the striker 22, and a second spring 72 biasing the latching block 71 toward the slot 222 is further provided on the support base 61. A cam 73 configured to unlock the latching block 71 is sleeved on the transmission shaft 42; the cam 73 can be unitarily formed with the lifting gear 41, or can be separately formed relative to the lifting gear 41. Normally, a part of the latching block 71 is fitted in the slot 222 to keep the striker 22, the piston 21, and the movable cylinder body 24 in the ready position. To perform a nailing action, the electric motor 43 first actuates the lifting gear 41, the transmission shaft 42, and the cam 73 to rotate in the +ω direction. The cam 73 rotating in the +ω direction drives the latching block 71 to overcome the bias of the second spring 72 to slide away from the slot 222, so that the latching block 71 releases the striker 22. Almost simultaneously, the transmission structure switches from the engaged state to the disengaged state; the released striker 22 is driven by the piston 21 to move rapidly downward, and the downward-moving striker 22 drives the lifting gear 41, the transmission shaft 42, and the driven wheel 452 to rotate reversely relative to the driving wheel 451. When the lifting gear 41 drives the striker 22 to move upward to the ready position, the latching block 71 is aligned with the slot 222, and the latching block 71 is biased by the second spring 72 to slide toward the slot 222 so as to be fitted in the slot 222, thereby locking the striker 22 to the ready position.

To enable the electric motor 43 to stop promptly, a limit switch 74 is fixedly provided on the support base 61, and a pin rod 75 configured to trigger the limit switch 74 is provided on the latching block 71. A main control board in communication with the limit switch 74 is provided in the enclosure 50, and the electric motor 43 is controlled by the main control board. The pin rod 75 releases the limit switch 74 when the latching block 71 migrates from the slot 222, and triggers the limit switch 74 when the latching block 71 is re-fitted in the slot 222. The main control board can command the electric motor 43 to stop in response to a trigger signal of the limit switch 74.

In this embodiment, a guide base 63 is secured on a front side of the support base 61. A limiting passage 64 in which the striker 22 moves up and down is formed between the guide base 63 and the support base 61. The fastener driving tool 100 further comprises a nail feeder 80 removably attached to the guide base 63, and a guide cover 81 is provided at a front end of the nail feeder 80. When the nail feeder 80 is attached to the guide base 63, the guide base 63 is fitted with the guide cover 81 to form a guide passage 65 open at both upper and lower ends. The nail feeder 80 outputs a to-be-driven fastener 31 into the guide passage 65, and the downward-moving striker 22 enters the guide passage 65 and drives the to-be-driven fastener 31 downward into the workpiece 32. The striker 22 moving upward to the ready position migrates upward from the guide passage 65, so that the nail feeder 80 can smoothly output a next to-be-driven fastener 31 into the guide passage 65. In this embodiment, the fastener 31 driven into the workpiece 32 can be a straight nail, a U-shaped nail, or another reasonable shape.

A main switch is provided inside a front end of the grip portion 53 and communicates with the main control board, and a trigger 66 configured to trigger the main switch is provided on a bottom side of the front end of the grip portion 53. The enclosure 50 is further provided with a reinforcement portion 55 disposed between the accommodation portion 52 and the battery connecting portion 54, and the main control board can be disposed in the reinforcement portion 55.

The fastener driving tool 100 is further provided with a safety assembly 90. Specifically, the safety assembly 90 comprises a driver rod 91, a safety switch 92, a third spring 93, a locating rack 95, and an elastic member 96, where the driver rod 91 is disposed at a front side of the guide base 63 in an up-down movable manner with a limited travel, an upper end of the driver rod 91 extends into the body portion 51 and is provided with a contact plate 94 configured to trigger the safety switch 92, the safety switch 92 can be secured on the support base 61 or on the guide base 63 and communicates with the main control board, the third spring 93 biases the driver rod 91 downward so that the contact plate 94 normally releases the safety switch 92, the locating rack 95 is secured to a lower end of the driver rod 91, and the elastic member 96 is sleeved outside the locating rack 95 or disposed at a bottom portion of the locating rack 95. To perform a nailing action, the locating rack 95 is pressed against the workpiece 32 and drives the driver rod 91 to move upward against the bias of the third spring 93 so that the contact plate 94 triggers the safety switch 92. Only when the safety switch 92 and the main switch are both triggered, can the tool initiate the nailing process; as to the sequence of triggering the safety switch 92 and the main switch, the present application has no limitation. To facilitate adjusting a nailing depth, the locating rack 95 is exemplarily connected to a lower end of the driver rod 91 via threaded fit.

After the nailing process is initiated, the rotating cam 73 drives the latching block 71 to migrate out of the slot 222, so that the latching block 71 releases the striker 22; the pressurized gas in the first gas chamber 10A acts on the movable cylinder body 24 so that the movable cylinder body 24 moves downward relative to the support cylinder 23, and the downward-moving movable cylinder body 24 drives the piston 21 and the striker 22 to move downward. At the same time, the pressurized gas in the second gas chamber 10B acts on the piston 21 so that the piston 21 moves downward relative to the movable cylinder body 24, and the downward-moving piston 21 drives the striker 22 to move downward. The downward-moving striker 22 extends into the guide passage 65 to drive the to-be-driven fastener 31 downward into the workpiece 32, and the lifting gear 41 rotates in the direction indicated by −ω during downward movement of the striker 22.

After the movable cylinder body 24, the piston 21, and the striker 22 move to the end position, the lifting gear 41 is actuated by the electric motor 43 to rotate in the direction indicated by +ω, the rotating lifting gear 41 drives the striker 22 and the piston 21 to move upward, the upward-moving piston 21 compresses the gas in the second gas chamber 10B to drive the movable cylinder body 24 to move upward, and the upward-moving movable cylinder body 24 compresses the gas in the first gas chamber 10A. When the striker 22 moves to the ready position, the electric motor 43 stops.

As an alternative solution to this embodiment, to control the travel of the striker 22, a magnetic induction switch can be used as an alternative to the limit switch 74. Specifically, a magnet is provided on the striker 22, and two magnetic induction elements distributed in an upper and lower direction are provided on the support base 61 and/or the guide base 63, the magnetic induction elements communicating with the main control board, so that the main control board determines a position of the striker 22 based on a triggering status of the magnetic induction elements. The magnetic induction elements can be Hall elements, reed switches, or the like. When the striker 22 moves to the position where the magnet triggers one of the magnetic induction elements, it indicates that the striker 22 has moved to the ready position. When the striker 22 moves to the position where the magnet triggers the other magnetic induction element, it indicates that the striker 22 has moved to the end position. Of course, the magnet can also be disposed on the lifting gear 41.

As an alternative solution to this embodiment, the transmission structure of the lifter 40 can also adopt an axially engageable/disengageable structure. In this case, the driven wheel 452 or the driving wheel 451 can slide axially. When nailing, the driving wheel 451 and the driven wheel 452 are in the disengaged state, so that the driven wheel 452 can rotate freely relative to the driving wheel 451; upon completion of the nailing, the driving wheel 451 and the driven wheel 452 return to the engaged state under the bias of the spring.

As an alternative solution to this embodiment, a connecting rod can also be provided between the striker 22 and the piston 21, an upper end of the striker 22 being connected to the connecting rod, an upper end of the connecting rod being connected to the piston 21, the convex teeth 221 meshing with the lifting gear 41 being disposed on the connecting rod. The lifting gear 41 rotating in the +ω direction drives, via the connecting rod, the striker 22 and the piston 21 to move upward toward the ready position.

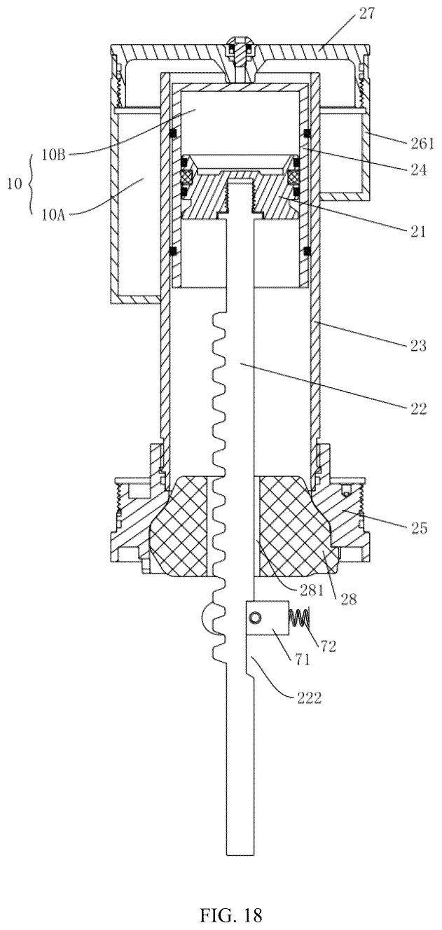

Referring to FIG. 18, as an alternative solution to this embodiment, the outer cylinder body 261 can be configured as a non-cylindrical irregular structure. In this case, the outer cylinder body 261 is disposed outside a partial section of the support cylinder 23, and the outer cylinder body 261 is not secured to the base 25. The outer cylinder body 261 and the support cylinder 23 can be unitarily formed, or can be separately formed and then secured together. Of course, the outer cylinder body 261 can also be configured into another reasonable structure.

As an alternative solution to this embodiment, the lifting gear 41 can be provided with a toothless portion, that is, the teeth on the lifting gear 41 are not continuously arranged along the circumferential direction. To perform a nailing action, the toothless portion of the lifting gear 41 faces the striker 22, allowing for avoiding the convex teeth 221 on the striker 22, so that the striker 22 can move downward smoothly, preventing the lifting gear 41 from interfering with the nailing action of the striker 22. Upon completion of the nailing, the lifting gear 41 rotating in the +ω direction re-meshes with the convex teeth 221 to drive the striker 22 upward toward the ready position. In this solution, the lifting gear 41 with the toothless portion can be directly sleeved on the output shaft 441 of the reduction gearbox 44, eliminating a need for the transmission shaft 42; of course, the lifting gear 41 can still be sleeved on the transmission shaft 42, in which case a coupling is arranged between the transmission shaft 42 and the output shaft 441.

As an alternative solution to this embodiment, the lifter 40 can also adopt the drive assembly 400 described in the utility patent CN221539660U. In this case, no convex teeth 221 are provided on the striker 22 of this embodiment; the rack used as a movable part 420 in CN221539660U is arranged to be movable up and down relative to the striker 22 in this embodiment.

As an alternative solution to this embodiment, the latching block 71 can also be pivotally disposed.

As an alternative solution to this embodiment, the cam 73 can be eliminated. In this case, the action of the latching block 71 releasing the striker 22 and the action of locking the striker 22 are both driven by an electromagnetic solenoid controlled by the main control board.

As an alternative solution to this embodiment, the piston 21, the striker 22, and the movable cylinder body 24 can also be normally disposed in the end position. When initiating a nailing cycle, the lifting gear 41 first actuates the striker 22, the piston 21, and the movable cylinder body 24 to move upward to the ready position. Then, the transmission structure switches to the disengaged state, and the pressurized gas in the two gas chambers drives the piston 21 and the striker 22 to move downward toward the end position. In this case, the latching block 71, the second spring 72, the cam 73, the limit switch 74, and the pin rod 75 can be eliminated.

As a further solution of this embodiment, the tool is provided with a single-shot mode and a continuous-shot mode. An operable mode selector is provided on the enclosure 50, and the user can switch a nailing mode of the tool through the mode selector. The mode selector can be configured as a bidirectionally sliding push block, a pivotal button, a rotary knob, a key, a touch screen, or another reasonable manner.

As a still further solution of this embodiment, to improve stability of the nail feeder 80, a quick-release connection structure can be provided between a rear end of the nail feeder 80 and the accommodation portion 52 of the enclosure 50.

### Second Embodiment

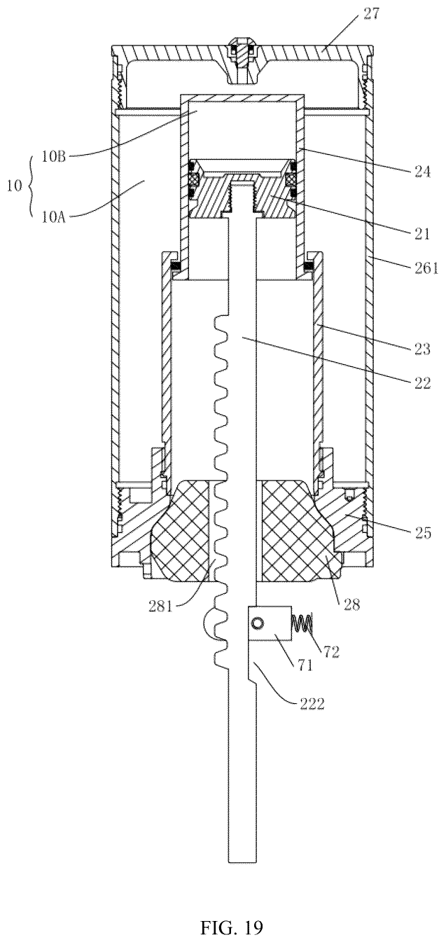

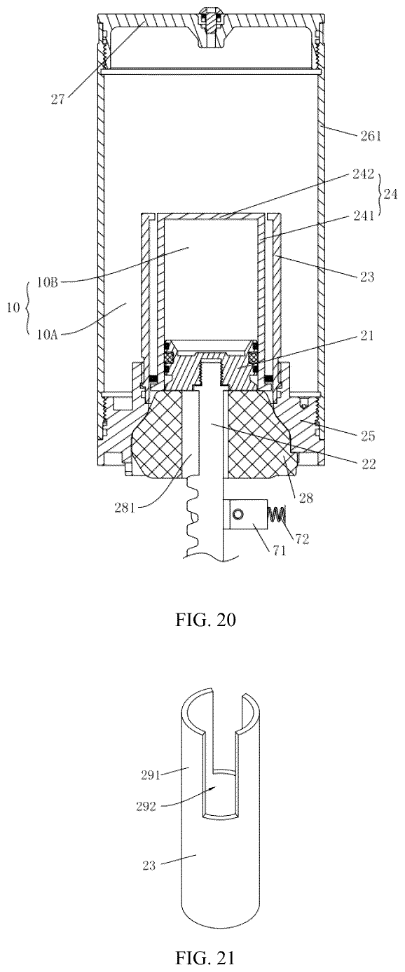

Referring to FIGS. 19 and 20, in this embodiment, an axial height of the support cylinder 23 is reduced; when the movable cylinder body 24 is disposed in the ready position, a larger section of the movable cylinder body 24 extends upward out of the support cylinder 23, while a lower end thereof remains in the support cylinder 23. When the movable cylinder body 24 is disposed in the end position, a top wall 242 of the movable cylinder body 24 is substantially flush with an upper end surface of the support cylinder 23 or slightly higher than the upper end surface of the support cylinder 23.

To ensure the nailing effect, the unidirectional travel of the movable cylinder body 24 is equal to or slightly greater than a length of a to-be-driven fastener.

To prevent the upward-moving movable cylinder body 24 from being detached from the support cylinder 23, a circle of limiting rib may be provided at an upper end of the support cylinder 23 and a lower end of the movable cylinder body 24, respectively, so that the movable cylinder body 24 is axially limited by the upper and lower circles of limiting rib.

Referring to FIG. 21, to enable the movable cylinder body 24 to move up and down smoothly relative to the support cylinder 23, a limiting portion 291 may be disposed over the support cylinder 23, the limiting portion 291 being configured to axially limit a section of the movable cylinder body 24 extending out of the support cylinder 23. The movable cylinder body 24 moving upward toward the ready position extends out of the support cylinder 23 into the limiting portion 291, so that the limiting portion 291 also has a certain guiding effect on the movable cylinder body 24. At least two limiting portions 291 are provided at intervals along an outer circumference of the movable cylinder body 24, with a flow channel 292 in which the gas in the first gas chamber 10A flows is provided between adjacent two limiting portions 291. A cross-sectional profile of the limiting portion 291 perpendicular to the axial direction is exemplarily arc-shaped, with its inner diameter slightly larger than an outer diameter of the movable cylinder body 24. The limiting portion 291 may be unitarily formed with the support cylinder 23, or unitarily formed with the cylinder head 27, or separately formed and then secured to the top of the support cylinder 23, the bottom of the cylinder head 27, or the inside of the outer cylinder body 261.

Other structures of Embodiment 2 are identical to those of Embodiment 1, which will not be detailed here.

### Third Embodiment

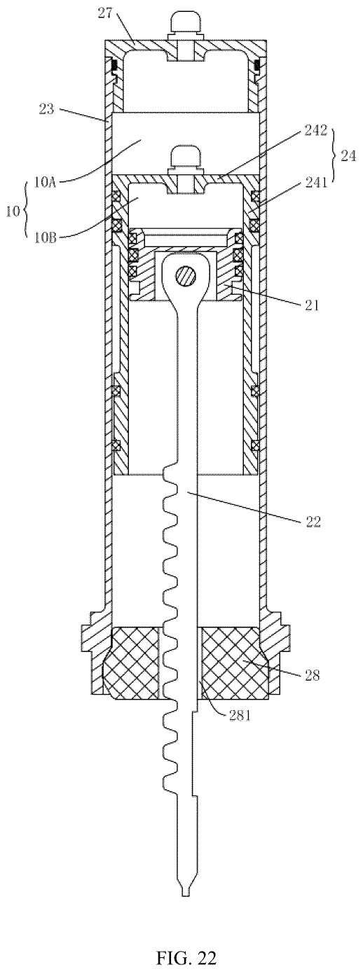

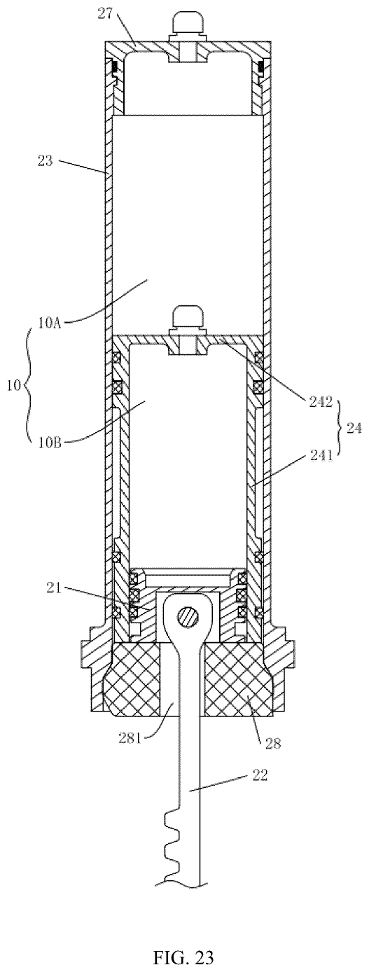

Referring to FIGS. 22 and 23, in this embodiment, the first gas chamber 10A is completely disposed at a top end of the movable cylinder body 24. Specifically, the outer cylinder body in Embodiment 1 is eliminated, the support cylinder 23 may be directly secured on the support base, the cylinder head 27 is adapted to the support cylinder 23 and directly secured at a top end of the support cylinder 23, and the damper block 28 is secured to an inner circumference of a lower end of the support cylinder 23. The movable cylinder body 24 still has a sidewall 241 and a top wall 242 disposed at a top end of the sidewall 241, and the movable cylinder body 24 is arranged in the support cylinder 23 and maintains a circumferential sealing fit therewith. An outer diameter of the support cylinder 23 is set uniformly from top to bottom, i.e., the support cylinder 23 is has a hollow straight cylinder shape. A space enclosed by the support cylinder 23, the cylinder head 27 and the top wall 242 of the movable cylinder body 24 defines the first gas chamber 10A, and a space enclosed by the movable cylinder body 24 and the piston 21 defines the second gas chamber 10B, the two gas chambers still not communicating with each other, and pressurized gas may be pre-filled in the two gas chambers. To adjust the gas pressure in the two gas chambers, an inflation valve may be provided on the cylinder head 27 and the top wall 242 of the movable cylinder body 24, and of course, an exhaust valve for relieving pressure in the first gas chamber 10A and the second gas chamber 10B may also be provided. As a feasible solution of this embodiment, the support cylinder 23 and the cylinder head 27 may be unitarily formed, or separately formed and then fixed together.

Referring to FIG. 22, when the piston 21, the striker 22 and the movable cylinder body 24 are disposed in the ready position, the first gas chamber 10A and the second gas chamber 10B are both in a high-pressure state.

To perform a nailing action, the pressurized gas in the first gas chamber 10A drives the movable cylinder body 24 to move downward relative to the support cylinder 23, and the downward-moving movable cylinder body 24 simultaneously drives the piston 21 and the striker 22 to move downward. At the same time, the pressurized gas in the second gas chamber 10B drives the piston 21 to move downward relative to the movable cylinder body 24, and the downward-moving piston 21 drives the striker 22 to move downward synchronously. The downward-moving striker 22 drives a to-be-driven fastener into the workpiece.

Referring to FIG. 23, when the movable cylinder body 24, the piston 21 and the striker 22 move downward to the end position, the movable cylinder body 24 and the piston 21 both abut against the damper block 28. Of course, when the movable cylinder body 24, the piston 21 and the striker 22 move downward to the end position, the piston 21 may also be disposed higher than the damper block 28 without abutting against the latter.

When the lifter drives the striker 22 to move upward toward the ready position, the striker 22 drives the piston 21 to move upward synchronously, the piston 21 moving upward relative to the movable cylinder body 24 compresses the gas in the second gas chamber 10B while the piston 21 drives the movable cylinder body 24 to move upward relative to the support cylinder 23, and the upward-moving movable cylinder body 24 compresses the gas in the first gas chamber 10A.

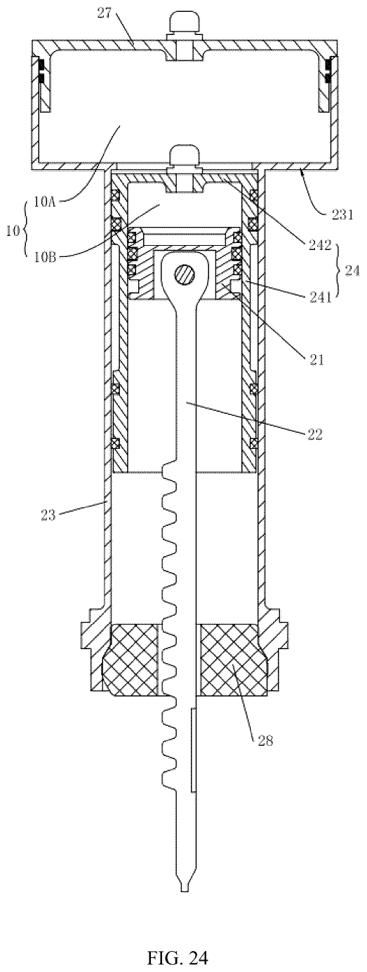

Referring to FIG. 24, in another solution of this embodiment, the support cylinder 23 has an outer diameter decreasing gradually from top to bottom and is formed with a stepped portion 231. Since the outer diameter of an upper portion of the support cylinder 23 is larger, the volume of the first gas chamber 10A can be effectively increased, thereby increasing the movement speed of the striker 22 during nailing, which helps to enhance the nailing effect. Furthermore, when the movable cylinder body 24, the piston 21 and the striker 22 are in the ready position, the movable cylinder body 24 is not higher than the stepped portion 231, i.e., the top wall 242 of the movable cylinder body 24 is slightly lower than or flush with the stepped portion 231, so that the entire first gas chamber 10A is always located at the top end of the movable cylinder body 24. The upper portion and the lower portion of the support cylinder 23 may be integrally formed, or separately formed and then fixed together. To limit the upward travel of the movable cylinder body 24, a convex rib configured to limit the movable cylinder body 24 may be arranged on an inner wall of the lower portion of the support cylinder 23 or at the stepped portion 231, so that the movable cylinder body 24 reaches the ready position when moving upward till abutting against the convex rib.

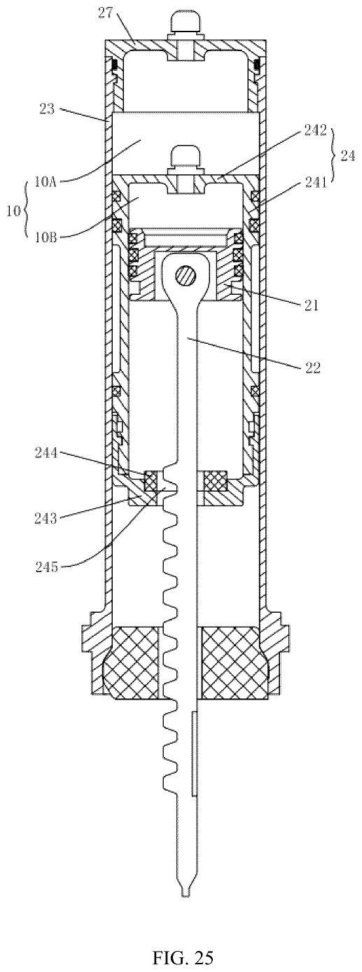

Referring to FIG. 25, in another solution of this embodiment, to prevent the piston 21 moving downward relative to the movable cylinder body 24 from being disengaged from the movable cylinder body 24, a limiting cover 243 is provided at the lower end of the movable cylinder body 24, an elastic block 244 is provided on a top side of the limiting cover 243 facing the movable cylinder body 24, the elastic block 244 being disposed below the piston 21, and the elastic block 244 and the limiting cover 243 are both provided with a clearance hole 245 for the striker to pass through. When the piston 21 moves downward relative to the movable cylinder body 24 till abutting against the elastic block 244, the piston 21 moves downward to an extreme position relative to the movable cylinder body 24. In this solution, when the movable cylinder body 24 moves downward to the end position, the limiting cover 243 may abut against the damper block 28, or the limiting cover 243 is disposed slightly higher than the damper block 28 without abutting against the latter; the piston 21 moving downward to the end position may abut against the elastic block 244, or be disposed slightly higher than the elastic block 244 without abutting against the latter. The limiting cover 243 may be connected to the lower end of the movable cylinder body 24 via threaded fit, twist fit, or the like; the elastic block 244 may be made of an elastic material such as rubber; and the clearance hole 245 is in clearance fit with the striker 22.

Remaining structures of Embodiment 3 are identical to those of Embodiment 1, which will not be detailed here.

### Fourth Embodiment

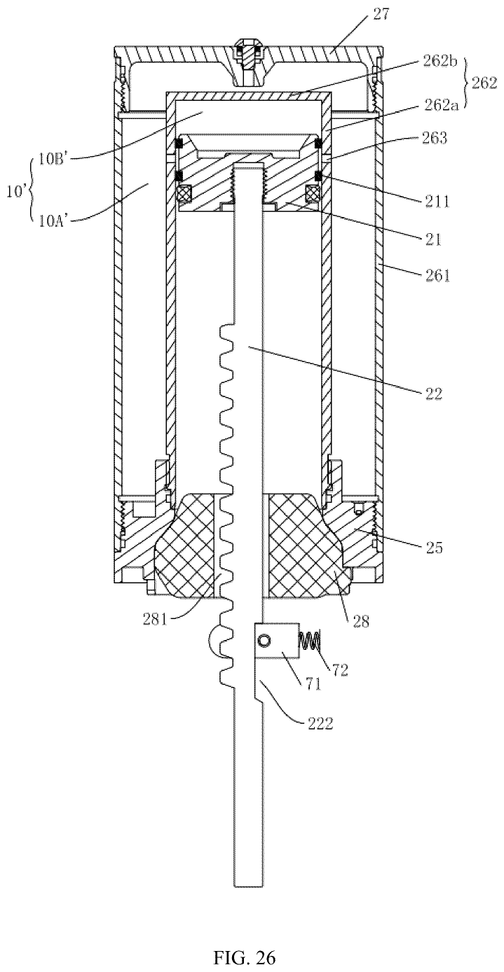

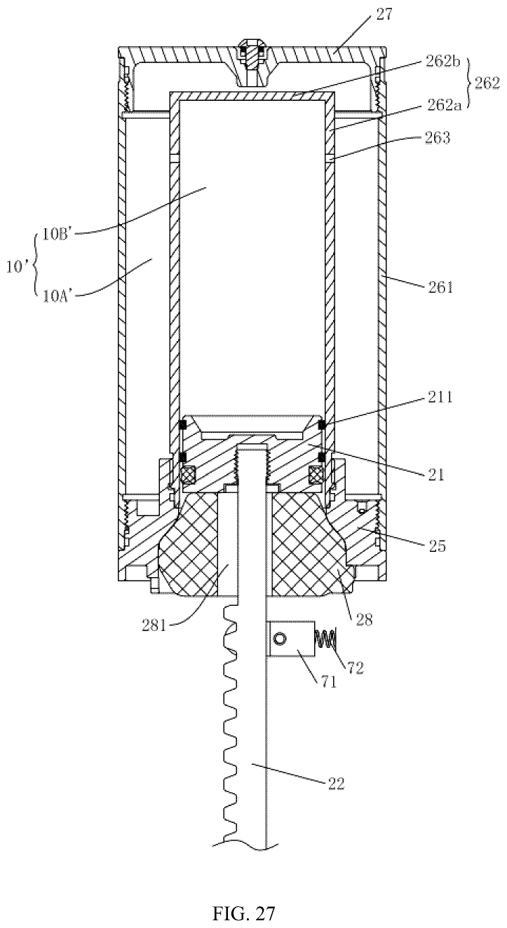

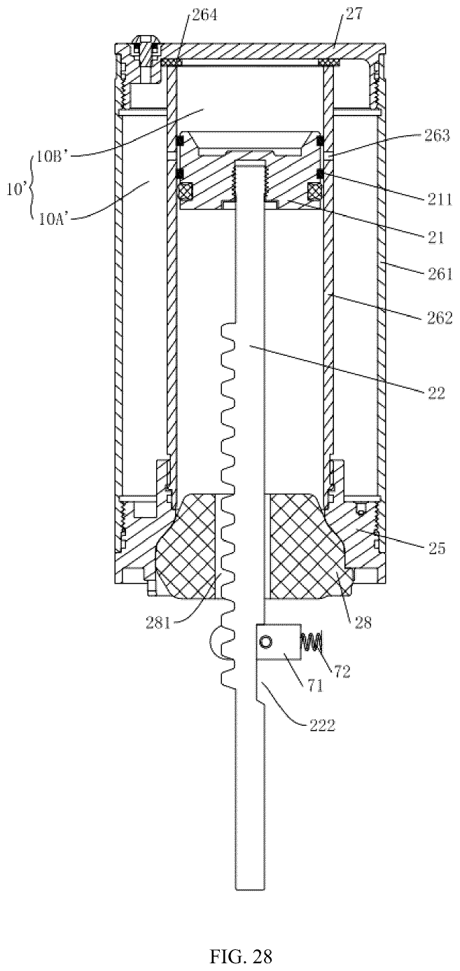

Referring to FIGS. 26 and 27, in this embodiment, the fastener driving tool comprises:
a gas chamber 10′, in which pressurized gas is filled;
a piston 21 movable up and down, the piston 21 being driven to move downward by the gas compressed in the gas chamber 10′;
a striker 22, an upper end of which is attached to the piston 21, the striker 22 moving downward with the piston 21 to drive a to-be-driven fastener into a workpiece;
a lifter configured to drive the piston 21 and the striker 22 to move upward;
the fastener driving tool further comprising an inner cylinder block 262, a through hole 263 being formed in an upper end of the inner cylinder block 262, where:
the piston 21 is disposed in the inner cylinder block 262, the piston 21 and the striker 22 having an upper ready position and a lower end position;
the gas chamber 10′ includes a first gas chamber 10A′ and a second gas chamber 10B′, the first gas chamber 10A′ being disposed outside the inner cylinder block 262, the second gas chamber 10B′ being defined at least by fitting between the inner cylinder block 262 and the piston 21;
the through hole 263 is opened when the piston 21 moves from the ready position to the end position so that the first gas chamber 10A′ communicates with the second gas chamber 10B′;
and the through hole 263 is closed when the piston 21 moves from the end position to the ready position so that the first gas chamber 10A′ is isolated from the second gas chamber 10B′.

To perform a nailing action, the pressurized gas in the second gas chamber 10B′ first drives the piston 21 and the striker 22 to move downward; when the piston 21 moves below the through hole 263, the through hole 263 is opened by the piston 21, allowing for the first gas chamber 10A′ and the second gas chamber 10B′ to communicate with each other, so that the pressurized gas in the first gas chamber 10A′ can flow into the second gas chamber 10B′ via the through hole 263 to jointly act on the piston 21, driving the piston 21 and the striker 22 to move downward. By using two communicable gas chambers, the piston 21 can be accelerated twice during nailing, which helps to increase the movement speed of the striker 22, thereby enhancing the nailing effect. In addition, with two gas chambers, the vibration produced from the striking action when the striker 22 engages the fastener can be damped twice by the gas in the two gas chambers, which can significantly reduce the vibration produced from the striking action while meeting the nailing requirements, thereby enhancing user experience.

In a specific solution of this embodiment, the inner cylinder block 262 comprises a side cylinder wall 262a extending in an upper and lower direction and a top cylinder wall 262b disposed at a top end of the side cylinder wall 262a. Irrespective of whether the piston is in the ready position or in the end position, a certain height difference is present between the piston 21 and the top cylinder wall 262b, and a certain height difference also exists between the through hole 263 and the top cylinder wall 262b. A space enclosed by the inner cylinder block 262 and the piston 21 defines the second gas chamber 10B′, and a space enclosed by the inner cylinder block 262, the outer cylinder body 261, the cylinder head 27 and the base 25 defines the first gas chamber 10A′. The volume of the first gas chamber 10A′ is always larger than that of the second gas chamber 10B′.

A plurality of sealing rings 211 distributed at intervals in an upper and lower direction and positioned axially are sleeved on an outer circumference of the piston 21, allowing for the piston 21 and the inner cylinder block 262 to maintain a circumferential sealing fit. When the piston 21 is in the ready position, the through hole 263 is axially located between two adjacent sealing rings 211, in which case the through hole 263 is closed by the piston 21, and the first gas chamber 10A′ and the second gas chamber 10B′ are isolated from each other.

While the lifter drives the striker 22 and the piston 21 is moving upward from the end position to the ready position, the piston 21 compresses the gas; since the two gas chambers communicate via the through hole 263, the gas in the two gas chambers is compressed with a temporarily consistent gas pressure before the piston 21 moves to close the through hole 263. After the piston 21 moves to close the through hole 263, the two gas chambers are isolated from each other, and the piston 21 continues to move upward for a short distance and continues compressing the gas in the second gas chamber 10B′. When the piston 21 and the striker 22 move to the ready position, the piston 21 closes the through hole 263, so that the second gas chamber 10B′ is temporarily isolated from the first gas chamber 10A′, the gas pressure in the second gas chamber 10B′ being higher than that in the first gas chamber 10A′.

When the through hole 263 is opened by the piston 21, to increase gas flow between the first gas chamber 10A′ and the second gas chamber 10B′, a plurality of through holes 263 are arranged at intervals along a circumferential direction of the inner cylinder block 262.

Referring to FIG. 28, in another specific solution of this embodiment, upper and lower ends of the inner cylinder block 262 are both open, an upper end of the inner cylinder block 262 extends till close to the cylinder head 27, and a sealing gasket 264 is arranged between an upper end surface of the inner cylinder block 262 and a lower surface of the cylinder head 27, allowing for the inner cylinder block 262 and the cylinder head 27 to maintain a sealing fit. In this case, the second gas chamber 10B′ is enclosed by the inner cylinder block 262, the cylinder head 27 and the piston 21, and the first gas chamber 10A′ is still enclosed by the inner cylinder block 262, the outer cylinder body 261, the cylinder head 27 and the base 25.

Remaining structures of Embodiment 4 are identical to those of Embodiment 1, which will not be detailed here.

In addition to the exemplary embodiments described supra, the present disclosure has other embodiments. Those skilled in the art may make various changes and modifications according to the present disclosure; all such changes and modifications without departing from the spirit of the present application shall fall within the scope defined in the appended claims.

1. A fastener driving tool, comprising:
a gas chamber in which pressurized gas is filled;
a piston movable up and down, the piston being driven to move downward by the gas compressed in the gas chamber;
a striker, an upper end of which is attached to the piston, the striker moving downward with the piston to drive a to-be-driven fastener into a workpiece;
and a lifter configured to drive the piston and the striker to move upward;
wherein the fastener driving tool further comprises a support cylinder and a movable cylinder body, where:
the support cylinder is fixedly disposed and extends in an upper and lower direction;
the movable cylinder body is disposed on an inner circumference of the support cylinder in an up-and-down movable manner, the movable cylinder body and the support cylinder maintain a circumferentially sealing fit, and the piston is disposed in the movable cylinder body in an up-and-down movable manner;
the gas chamber includes a first gas chamber and a second gas chamber isolated from each other, where:
the first gas chamber is disposed outside the movable cylinder body, the movable cylinder body is driven by the gas compressed in the first gas chamber to move downward relative to the support cylinder, the movable cylinder body is driven by the piston moving upward to move upward relative to the support cylinder, and the movable cylinder body moving upward compresses the gas in the first gas chamber;
and the second gas chamber is formed by fitting between the movable cylinder body and the piston, the piston is driven by the gas compressed in the second gas chamber to move downward relative to the movable cylinder body, and the gas in the second gas chamber is compressed by the piston moving upward.

2. The fastener driving tool according to claim 1, wherein the movable cylinder body has a sidewall and a top wall located at a top end of the sidewall, the first gas chamber being at least partially located above the top wall.

3. The fastener driving tool according to claim 1, wherein the piston, the striker, and the movable cylinder body have a ready position, the movable cylinder body in the ready position being completely disposed in the support cylinder.

4. The fastener driving tool according to claim 1, wherein the piston, the striker, and the movable cylinder body have a ready position, the movable cylinder body in the ready position being disposed at least partially higher than the support cylinder.

5. The fastener driving tool according to claim 4, wherein a limiting portion adapted to the movable cylinder body is provided over the support cylinder, and the movable cylinder body moving toward the ready position is extendable out of the support cylinder into the limiting portion.

6. The fastener driving tool according to claim 4, wherein the piston, the striker, and the movable cylinder body have an end position, an upper end of the movable cylinder body in the end position being higher than or flush with an upper end of the support cylinder.

7. The fastener driving tool according to claim 3, wherein the piston, the striker, and the movable cylinder body have an end position, and the fastener driving tool further comprises a damper block secured at a lower end of the support cylinder, a lower end of the movable cylinder body in the end position being pressed on the damper block.

8. The fastener driving tool according to claim 1, wherein the movable cylinder body has a sidewall and a top wall located at a top end of the sidewall, the first gas chamber being disposed completely at the top end of the movable cylinder body.

9. The fastener driving tool according to claim 8, wherein a cylinder head is provided at an upper end of the support cylinder, and the first gas chamber is enclosed by the support cylinder, the cylinder head, and the top wall of the movable cylinder body.

10. The fastener driving tool according to claim 9, wherein the support cylinder has an outer diameter consistent from top to bottom; or, the support cylinder has an outer diameter decreasing gradually from top to bottom with a stepped portion formed, the movable cylinder body being always not higher than the stepped portion.

11. The fastener driving tool according to claim 8, wherein a limiting cover is provided at the lower end of the movable cylinder body, an elastic block is provided at one side of the limiting cover facing the movable cylinder body and located below the piston, and the elastic block and the limiting cover are both provided with a clearance hole for the striker to pass through.

12. A fastener driving tool, comprising:
a gas chamber, in which pressurized gas is filled;
a piston movable up and down, the piston being driven to move downward by the gas compressed in the gas chamber;
a striker, an upper end of which is attached to the piston, the striker moving downward with the piston to drive a to-be-driven fastener into a workpiece;
a lifter configured to drive the piston and the striker to move upward;
wherein the fastener driving tool further comprises an inner cylinder block, a through hole being formed in an upper end of the inner cylinder block, where:
the piston is disposed in the inner cylinder block, the piston and the striker having an upper ready position and a lower end position;
the gas chamber includes a first gas chamber and a second gas chamber, the first gas chamber being disposed outside the inner cylinder block, the second gas chamber being defined at least by fitting between the inner cylinder block and the piston;
the through hole is opened when the piston moves from the ready position to the end position so that the first gas chamber communicates with the second gas chamber;
and the through hole is closed when the piston moves from the end position to the ready position so that the first gas chamber is isolated from the second gas chamber.

13. The fastener driving tool according to claim 12, wherein a plurality of through holes are distributed at intervals along a circumferential direction of the inner cylinder block.

14. The fastener driving tool according to claim 12, wherein a sealing ring is provided between the piston and the inner cylinder block to maintain a circumferential sealing fit therebetween; at least two sealing rings are provided at an interval in an upper and lower direction; and the through holes are located between adjacent two sealing rings when the piston is in the ready position.

15. The fastener driving tool according to claim 4, wherein the piston, the striker, and the movable cylinder body have an end position, and the fastener driving tool further comprises a damper block secured at a lower end of the support cylinder, a lower end of the movable cylinder body in the end position being pressed on the damper block.
